(19) United States
(12) Patent Application Publication
(10) Pub. No.: US 2026/0027995 A1
(43) Pub. Date: Jan. 29, 2026

(54) SPOT ON CONTROL SYSTEM FOR VEHICLE WASH FACILITIES

(71) Applicant: Claire Cunningham, Mission Hills, KS (US)

(72) Inventors: Claire Cunningham, Mission Hills, KS (US); Jason Cunningham, Mission Hills, KS (US)

(21) Appl. No.: 18/637,894

(22) Filed: Apr. 17, 2024

(51) Int. Cl. B60S 3/04

(52) U.S. Cl. CPC B60S 3/04

(57) ABSTRACT

A system for controlling wash facility operations is provided comprising a chemical pod device located at a vehicle wash facility and a control system with functionality to observe and manipulate operations of the pod device. The system receives a first message from the pod, the first message describing a performance condition of at least one hardware component of the pod. The system processes the first message with other data describing at least activity at the facility. Based on at least the processing and on inputs received from a mobile device, the system sends a second message to the chemical pod containing instructions for configuration of at the least one hardware component. The control system is located onsite or remotely from the wash facility and observes and manipulates operations of pod devices located at numerous wash facilities. It observes and controls sensors and actuators associated with components at the wash facilities.

### CROSS REFERENCE TO RELATED APPLICATIONS

The present disclosure is related to U.S. Non-Provisional patent application Ser. No. 18/586,438 filed Feb. 24, 2024, the contents of which are incorporated herein in their entirety.

### FIELD OF THE DISCLOSURE

The present disclosure is in the field of vehicle wash facility management. More particularly, the present disclosure provides systems and methods of a control system with both remote and onsite components observing and controlling chemical distribution pods and cleaning systems at a plurality of vehicle wash facilities, systems further including mobile devices carried by managers that enable remote control and adjustment of flow volume and dilution levels of chemicals, water, and air at wash facilities without a need for manual replacement or configuration of applicators or other wash facility hardware.

### BACKGROUND

Managing vehicle wash facilities is labor intensive and very hands-on in nature, requiring significant management resources to profitably run a wash facility, and with greater resources required to manage a network or chain of facilities. Wash facilities use a great deal of chemicals, water, electricity and manpower. Such resources can be used excessively without management awareness for days or longer at a time. In many cases, management can only rely on estimates with days or weeks passing before incorrect use is discovered. Wash facility equipment can be inexact in its use of materials and often requires visual observation and manual adjustment.

Management expertise is required in wash facility development, financing, building, branding, equipment installation, chemicals, repairs, maintenance, marketing, membership clubs, and training. Wash facilities are increasingly subject to local, state and federal regulations in areas environmental compliance, safety and employment.

Wash facilities must deal with limited capacity and space constraints. Insufficient space or a limited number of bays may cause extended customer wait times or service delays during peak hours. Wash facilities must deal with seasonal dependency comprising vulnerability to fluctuations in demand due to seasonal variations which impact revenue during off-peak periods. Wash facilities may rely on skilled labor for specialized services, potentially leading to recruitment and training challenges. Facilities depend on complex machinery and technology, risking service disruptions if not adequately maintained. Facilities must implement robust maintenance schedules and contingency plans to minimize disruptions caused by equipment and software failures.

Facilities may create tailored packages and discounts for businesses with multiple vehicles, emphasizing cost-effectiveness and superior service quality.

### BRIEF DESCRIPTION OF THE FIGURES

FIG. 1 is a block diagram of a spot-on control system for vehicle wash facilities according to an embodiment of the present disclosure.

### DETAILED DESCRIPTION

Systems and methods described herein provide a control system for monitoring and managing numerous vehicle wash facilities from a single mobile device. Working closely with an ecosystem of control system computers located at or remote from a wash facility and with chemical pod devices situated at wash facilities, a dashboard on a mobile device provided herein displays resource usage data, performance metrics, business volume including vehicles serviced, revenue and expenses, and other information. Health monitoring of wash facility hardware in the ecosystem of wash facilities, chemical pods, and control system components is analyzed to provide predictive maintenance instructions for wash facility operators to minimize downtime and optimize equipment lifespans.

The control system includes physical hardware components, software components and configuration settings that may be located at the wash facility or remotely, some of which may be hosted in cloud storage. Applications hosted by the control system allow for complete, real-time electronic control of resource flow for the wash facility. The control system, via at least instructions entered into mobile devices, directs components of chemical pods to alter the flow of chemical, water and air. The control system reflects real-time changes in the dashboard displayed by the mobile device with updated data based on implementation control system instructions.

The control system provides for remote and non-manual adjustment of chemical, water and air resources. Adjustments to these resources may be made from the mobile device via the dashboard. In embodiments, adjustments may also be made by accessing a secure Internet website from desktop or laptop machines by users with adequate permissions. In most embodiments, the mobile device would be in possession of managers or supervisors of a single or multiple wash facilities, each person with permissions based on their authority.

Components of the control system and chemical pods that control flow of chemicals, water and air may provide for an infinite number of dilution and flow rates. These settings are not limited by the size of dials, metering tips or other restrictive flow devices used in other systems. Each element controlled through the system has a built-in feedback loop for assurance that the system is performing as designed. Calculations performed by the control system use real time data when populating the dashboard for cost per vehicle services at a per chemical or per wash level.

The control system allows users to set data thresholds for each component being monitored. Alerts may be configured such that specified users may receive notifications in the event configured thresholds are breached or an emergency occurs. Because the system does not utilize dials, metering tips or other restrictive flow devices that need to be cleaned or replaced regularly to ensure proper operation, the system is designed for reliability and low maintenance.

Chemical pod devices and associated measurement and resource distribution equipment on site at wash facilities are outfitted with actuator devices, wireless and wired transceiver devices, and other hardware and software. These components send and receive messages to the control system computer and mobile devices and execute instructions received therefrom. The associated equipment includes at least flow monitors, applicators, and sensors. Video equipment may also be included to count vehicles entering the facility, measure dimensions of such vehicles, and report this information back through the pod or directly to a control system computer.

The control system is an ecosystem of hardware and software hosted locally at the wash facility, on mobile devices carried by at least managers and analysts, and in cloud backup for redundancy. The control system allows for on-site access via HMI (Human Machine Interface) for electronic updates to resources as well as remote analysis, communications, and management from the mobile devices and other Internet-enabled devices. Software executed by the control system promotes real-time electronic control of resource flow for the wash facility.

The control system, via instructions entered into mobile devices and Internet web sites by authorized persons, directs resources of the pod to alter the flow of resources comprising at least one of chemical, water and air by at least one applicator at a wash facility. This action may be the result of analysis by a control system computer or a mobile device of data received from a pod or one of its components revealing not optimal use of resources including wasting of resources.

The control system computer may receive on a regular basis data pushed to it by components of the chemical pod and other cleaning system components at a wash facility. The control system computer may also receive, process, and send information about components not directly connected with vehicle washing such as cash registers, credit and debit card readers, refrigerators, security cameras and lottery ticket sales areas.

The control system reflects real-time changes of wash facility components in the dashboard executing on the mobile device with updated data based at least on implementation of instructions entered by a user of the mobile device. Adjustments to resources used in the wash facility are controlled electronically and without physical swapping of components or manual intervention. The dashboard displayed on the mobile devices enables the user to transmit commands to the control system to cause a plurality of actions by components of the chemical pod.

Unlike systems that utilize fixed water restriction devices, the control system enables electronic adjustment by mobile devices for water flow to allow unlimited flow rates. The control system further enables electronic adjustment of air flow via electropneumatic air regular devices unlike systems that utilize manual air regulation devices. The control system also enables many dilution and flow rates for fluid resources and enables calculation of amounts of chemical resources used per vehicle serviced. Based on observing a population of vehicles passing through a wash facility, the control system along with the chemical pod can observe the amounts of chemicals and water being used and make analyses of such usage.

This analysis may be displayed by the dashboard on a manager's mobile device allowing the manager to perform further analysis if desired and enter instructions for adjustments to components of the chemical pod or other components at the wash facility of interest or numerous wash facilities. Adjustments to components may be to increase or decrease resource flow or some other adjustment.

Chemical volume may be measurable by at least one of milliliters per vehicle, milliliters per second, and dilution rate. The control system is configurable to automatically adapt resource flow based upon recent local weather conditions via a weather application software plugin.

Flow monitors and applicators at wash facilities pull water in a single closed system of the chemical pod. The control system may receive alerts and messages from flow monitors about flow of water through applicators at a wash facility. The control system may automatically adjust flow of water based upon input from redundant feedback sensors. This may promote water dispensing accuracy and optimization of the cleaning system and allow for electronic adjustment to water flow based upon directives received via the control system, whether the control system and associated mobile devices are on site at a wash facility or remotely located.

The control system working with chemical pods at wash facilities replaces fixed water flow restriction devices and may reduce or eliminate the need to manually adjust or physically replace fixed water restriction devices. The control system may further reduce or eliminate the need to change out metering tips to adjust application flow of chemical resources. The control system promotes alteration of water flow to achieve desired dilution ratios for cleaning system optimization.

For managing air flow at wash facility locations, the control system works with chemical pod and chemical system components including air manifold components including air inputs and electropneumatic air regulators for air lines. The control system receives alerts and messages via air regulators about flow of air through air lines. Air manifold components and electropneumatic air regulators may be electronically adjusted for at least air flow based at least on orders received from a control system computer and/or mobile device with updates to the dashboard of the mobile device.

Fixed manual air regulation devices are replaced by the system which reduces or eliminates the need to manually adjust or physically replace manual air regulation devices on site at wash facilities. The control system promotes optimal aeration of chemicals, for example soaps and solvents, dispensed at the wash facility to achieve the desired foaming and presentation when the chemicals are applied to vehicles.

The control system may actively measure vehicle sizes including lengths of vehicles as vehicles enter wash facility tunnels adjusts. The control system may automatically or upon instruction received from a mobile device adjust application of chemicals, water, and/or air to optimize the cleaning system on a per vehicle basis. The control system calculates real time average vehicle length and may use actual live data when populating resource cost per vehicle, and other metrics, in the dashboard displayed by the mobile device. The control system is configurable to automatically adapt resource application based upon vehicle recognition and computer learning to optimize the cleaning system.

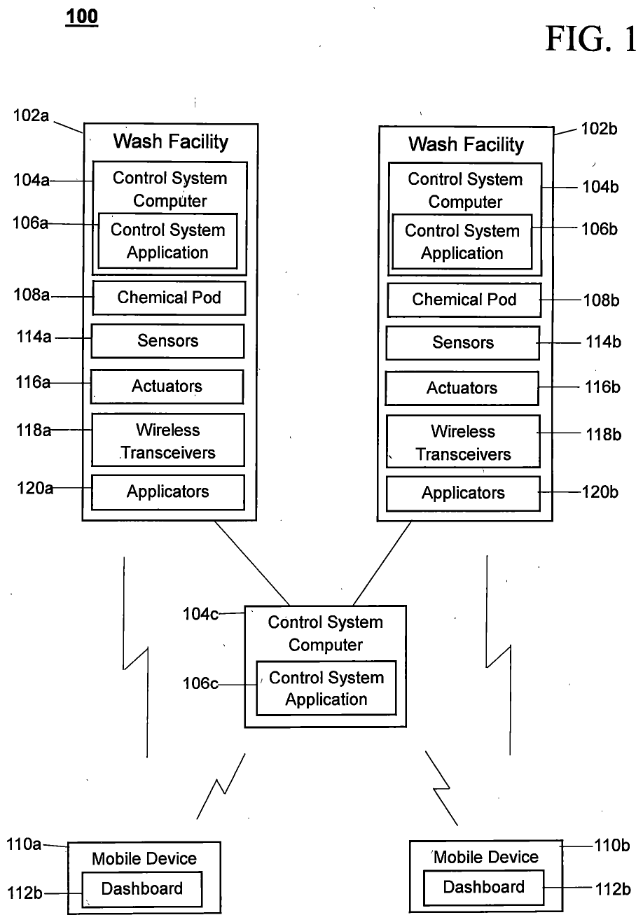

Turning to the figures, FIG. 1 depicts components and interactions of a system 100 of a control system for wash facilities. The system 100 comprises wash facilities 102a-b, control system computers 104a-c, control system applications 106a-c, and chemical pods 108a-b. The system 100 also comprises mobile devices 110a-b and dashboards 112a-c. The system 100 also comprises sensors 114a-b, actuators 116a-b, wireless transceivers 118a-b, and applicators 120a-b.

The wash facilities 102a-b may be facilities for washing vehicles including automobiles, trucks, vans, and buses. While FIG. 1 depicts the system 100 providing only quantity two of wash facilities 102a-b, this is for illustration and discussion purposes only such that in embodiments there may be many more than two wash facilities 102a-b and in other embodiments there may be only a single wash facility 102a. The system 100 has the capacity to support many wash facilities 102a-b simultaneously or a single wash facility 102a.

The control system computer 104a-c is located on site at wash facilities 102a-b in the case of control system computer 104a-b or may be remote in the case of control system computer 102c. Unless otherwise noted, functionality of onsite control system computers 104a-b and remote control system computer 104c is the same and discussion of one is assumed to apply to all.

The control system application 106a-c executes on the control system computer 104a-c. The control system application 106a-c provides much of the functionality of systems and methods provided herein including communicating with the chemical pod 108a-b and associated components, analyzing activity of vehicles entering and passing through wash facilities 102a-b, analyzing usage of chemicals, water, air, and other assets, and implementing instructions received from mobile devices 110a-b and other authorized devices and parties.

While the control system application 106a-c is illustrated in FIG. 1 as executing on the control system computers 104a-c, portions of the control system application 106a-c execute on the mobile devices 110a-b which are capable of handling significant communication, analysis and storage functionality. As is shown in FIG. 1, the mobile devices 110a-b communicate wirelessly with the control system computer 104c that is remotely located and communicate wirelessly with the onsite control system computers 104a-b to send instructions and receive reports and updates. In embodiments, the mobile devices 110a-c may communicate directly with the chemical pods 108a-b.

While the control system application 106a-c may perform much of the heavy analysis and storage of data, the mobile devices 110a-b via at least the dashboards 112a-b are capable of receiving some data directly from the chemical pods 108a-b and its components and sending some instructions directly thereto, even if the processing and storage capacity of the mobile devices 110a-b may not as robust as that of the control system computers 104a-c. The dashboards 112a-b executing on and displayed by the mobile devices 110a-b perform some analysis and display significant data for viewing by the user of the mobile devices 110a-b. The user via the dashboard 112a-b can make numerous configuration adjustments to chemical pod components at multiple wash facilities 102a-b. The user can order supplies for wash facilities 102a-b from the mobile device 110a-b.

For some types of actions, the control system computers 104a-c can make decisions and act unilaterally without the need for oversight and approval by a user of the mobile device 110a-b. For other actions, mobile device involvement and approval by mobile device users may be required.

The chemical pod 108a-b is a rack assembly, upright in form factor, that includes chemical tanks, inventory control, level sensors, usage monitoring, and chemical dosing pumps. Proportional water valves and electropneumatic air regulators are also key components.

The chemical pod 108a-b includes a chemical monitoring module that is associated with at least one applicator 120a-b at the wash facility 102a-b. The pod 108a-b receives instructions from mobile devices 110a-b and control system computers 104a-c about altering chemical volume and dilution rates at applicators 120a-b via the chemical monitoring module.

The chemical pod 108a-b also comprises flow monitors and applicators 120a-b that pull water in a single closed system of the pod 108a-b. The pod 108a-b, with the assistance of the control system computers 104a-c, adjusts water flow based on input from redundant feedback sensors 114a-b to ensure accuracy and optimization of the cleaning system. Data about the adjustments to water flow are sent back to control system computers 104a-c and mobile devices 110a-b.

The chemical pod 108a-b promotes correct usage of water through applicators 120a-b by using a flow meter that provides feedback to control system computers 104a-c and mobile devices 110a-b. Because multiple applicators 120a-b are pulling water in the same closed system in series, the system 100 adjusts water flow to achieve the desired gallons per minute or other measure at each applicator 120a-b.

The control system computers 104a-c and the mobile devices 110a-b may compare actual activity volume to actual resource usage over various periods of time to calculate true cost of washing vehicle and may implement changes to chemical pods 108a-b based on these comparisons. The control system computers 104a-c and the mobile devices 110a-b may use artificial intelligence applications to analyze upcoming weather trends and past activity volume to achieve a predictive wash activity level.

Current chemical inventory, actual chemical usage and predictive wash activity are used to achieve a predictive chemical order from suppliers. Inputs processed by control system computers 104a-c and the mobile devices 110a-b may describe historical performance of hardware components including service records and problem records involving the at least one hardware component.

In an embodiment, a system for controlling wash facility operations is provided. The system comprises a chemical pod device located at a vehicle wash facility and a control system with functionality to observe and manipulate operations of the device. The system receives a first message from the pod, the first message describing a performance condition of at least one hardware component of the pod. The system processes the first message with other data describing at least activity volume at the facility. Based on at least the processing and inputs received from a mobile device, the system sends a second message to the chemical pod, the second message containing instructions for configuration of at least one hardware component.

The control system is one of located onsite at and remotely from the wash facility and observes and manipulates operations of chemical pod devices located at a plurality of wash facilities. The control system observes and controls sensors and actuators associated with hardware components at the wash facilities.

The performance condition describes resource usage, resources comprising at least one of chemicals, water, and air. The processing and the inputs and the resulting second message are directed to correcting the performance condition. The mobile device provides a dashboard displaying wash facility data prompting a user to perform analysis of the wash facility data. Activity volume describes at least volume of vehicles passing through the facility.

Actual activity volume is compared to actual resource usage to calculate true cost of washing a vehicle. Artificial intelligence is used to analyze upcoming weather trends and past activity volume to achieve a predictive wash activity level.

Current chemical inventory, actual chemical usage and predictive wash activity are used to achieve a predictive chemical order from suppliers. The other data further describe historical performance of the at least one hardware component including service records and problem records involving the at least one hardware component. Health monitoring of wash facility hardware in an ecosystem of wash facilities, chemical pods, and control system components is analyzed to provide predictive maintenance instructions for operators to minimize downtime and optimize equipment lifespan.

In another embodiment, a method for remotely managing operations at a plurality of vehicle wash facilities is provided. The method comprises a control system mobile device contacting chemical pod devices at a plurality of wash facilities. The method also comprises the device querying sensors associated with at least a first component of each wash facility. The method also comprises the device analyzing data received from the sensors and analyzing data stored by at least one control system computer, the received and stored data describing at least performance of the at least first component. The method also comprises the device displaying the received and stored data in dashboard interfaces, the displaying promoting further analysis. The method also comprises the device, based at least on the analysis, transmitting instructions to the chemical pod devices to execute a first instruction associated with the at least first component.

The method also comprises the mobile device coordinating with the control system computer to observe and manipulate operations of a plurality of chemical pod devices located at a plurality of wash facilities. The method also comprises the mobile device querying the sensors based on data suggesting incorrect resource usage at the plurality of wash facilities.

The method also comprises the mobile device entering orders causing adjustment of air, water, and chemical volumes for applicators in wash facility tunnels. The dashboard interfaces promote a user of the mobile device to make a plurality of adjustments to chemical pod components. The mobile device monitors usage of resources at the plurality of wash facilities, the resources comprising at least chemicals, water, and air.

In yet another embodiment, a system for overseeing and controlling resource usage at a plurality of vehicle wash facilities is provided. The system comprises a control system computer monitoring operations of a plurality of vehicle wash facilities. The system receives analysis material of wash facility performance data from a control system mobile device, the data describing historical performance at a first wash facility. The system also combines the received analysis material with locally stored data describing current performance at the facility. The system also performs further analysis of the received analysis material from the mobile device and the locally stored data describing current performance, the further analysis directed to identifying trends suggesting inappropriate use of resources at the first wash facility. Based on the further analysis and approval communications received from the mobile device, the system remotely executes adjustments to at least one component at the first wash facility.

The control system computer and the control system mobile device work in conjunction with chemical pod devices located at each of the plurality of wash facilities. The control system computer and the control system mobile device observe and control, via at least the chemical pod devices, sensors and actuators associated with hardware components at the wash facilities.

The control system computer unilaterally executes adjustments to wash facility components and executes adjustments ordered by the mobile device. The mobile device is operated in a supervisory role over the plurality of wash facilities. Each of the control system computer and the mobile device performs analysis unilaterally and collaboratively of chemical pods and associated components located at the plurality of wash facilities.

1. A system for controlling wash facility operations, comprising:
a chemical pod device located at a vehicle wash facility; and
a control system with functionality to observe and manipulate operations of the device that:
receives a first message from the pod, the first message describing a performance condition of at least one hardware component of the pod,
processes the first message with other data describing at least activity volume at the facility,
based on at least the processing and inputs received from a mobile device, sends a second message to the chemical pod, the second message containing instructions for configuration of the at least one hardware component.

2. The system of claim 1, wherein the control system is one of located onsite at and remotely from the wash facility and observes and manipulates operations of chemical pod devices located at a plurality of wash facilities.

3. The system of claim 1, wherein the control system observes and controls sensors and actuators associated with hardware components at the wash facilities.

4. The system of claim 1, wherein the performance condition describes resource usage, resources comprising at least one of chemicals, water, and air.

5. The system of claim 1, wherein the processing and the inputs and the resulting second message are directed to correcting the performance condition.

6. The system of claim 1, wherein the mobile device provides a dashboard displaying wash facility data prompting a user to perform analysis of the wash facility data.

7. The system of claim 1, wherein activity volume describes at least volume of vehicles passing through the facility.

8. The system of claim 1, wherein actual activity volume is compared to actual resource usage to calculate true cost of washing a vehicle.

9. The system of claim 1, wherein artificial intelligence is used to analyze upcoming weather trends and past activity volume to achieve a predictive wash activity level.

10. The system of claim 1, wherein current chemical inventory, actual chemical usage and predictive wash activity are used to achieve a predictive chemical order from suppliers.

11. The system of claim 1, wherein the other inputs further describe historical performance of the at least one hardware component including service records and problem records involving the at least one hardware component.

12. The system of claim 1, wherein health monitoring of wash facility hardware in an ecosystem of wash facilities, chemical pods, and control system components is analyzed to provide predictive maintenance instructions for operators to minimize downtime and optimize equipment lifespan.

13. A method for remotely managing operations at a plurality of vehicle wash facilities, comprising:
a control system mobile device contacting chemical pod devices at a plurality of wash facilities;
the device querying sensors associated with at least a first component of each wash facility;
the device analyzing data received from the sensors and analyzing data stored by at least one control system computer, the received and stored data describing at least performance of the at least first component;
the device displaying the received and stored data in dashboard interfaces, the displaying promoting further analysis; and
the device, based at least on the analysis, transmitting instructions to the chemical pod devices to execute a first instruction associated with the at least first component.

14. The method of claim 13, further comprising the mobile device coordinating with the control system computer to observe and manipulate operations of a plurality of chemical pod devices located at a plurality of wash facilities.

15. The method of claim 13, further comprising the mobile device querying the sensors based on data suggesting incorrect resource usage at the plurality of wash facilities.

16. The method of claim 13, further comprising the mobile device entering orders causing adjustment of air, water, and chemical volumes for applicators in wash facility tunnels.

17. The method of claim 13, wherein the dashboard interfaces promote a user of the mobile device to make a plurality of adjustments to chemical pod components.

18. The method of claim 13, wherein the mobile device monitors usage of resources at the plurality of wash facilities, the resources comprising at least chemicals, water, and air.

19. A system for overseeing and controlling resource usage at a plurality of vehicle wash facilities, comprising:
a control system computer monitoring operations of a plurality of vehicle wash facilities that:
receives analysis material of wash facility performance data from a control system mobile device, the data describing historical performance at a first wash facility;
combines the received analysis material with locally stored data describing current performance at the facility;
performs further analysis of the received analysis material from the mobile device and the locally stored data describing current performance, the further analysis directed to identifying trends suggesting inappropriate use of resources at the first wash facility; and
based on the further analysis and approval communications received from the mobile device, remotely executes adjustments to at least one component at the first wash facility.

20. The system of claim 19, wherein the control system computer and the control system mobile device work in conjunction with chemical pod devices located at each of the plurality of wash facilities.

21. The system of claim 19, wherein the control system computer and the control system mobile device observe and control, via at least the chemical pod devices, sensors and actuators associated with hardware components at the wash facilities.

22. The system of claim 19, wherein the control system computer unilaterally executes adjustments to wash facility components and executes adjustments ordered by the mobile device.

23. The system of claim 19, wherein the mobile device is operated in a supervisory role over the plurality of wash facilities.

24. The system of claim 19, wherein each of the control system computer and the mobile device performs analysis unilaterally and collaboratively of chemical pods and associated components located at the plurality of wash facilities.
